(19) United States
(12) Patent Application Publication
(10) Pub. No.: US 2010/0032610 A1
(43) Pub. Date: Feb. 11, 2010

(54) COMPOSITIONS COMPRISING 1,2,3,3,3-PENTAFLUOROPROPENE WITH Z- AND E-ISOMER RATIO OPTIMIZED FOR REFRIGERATION PERFORMANCE

(76) Inventors: Mario Joseph Nappa, Newark, DE (US); Barbara Haviland Minor, Elkton, MD (US); Charles Joseph Noelke, Pinehurst, NC (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/517,577

(22) PCT Filed: Dec. 12, 2007
(86) PCT No.: PCT/US07/25383

§ 371 Date: Jun. 4, 2009

Related U.S. Application Data
(60) Provisional application No. 60/875,077, filed on Dec. 15, 2006.

(51) Int. Cl. C09K 5/00

(52) U.S. Cl. 252/67

(57) ABSTRACT

Azeotropic or near-azeotropic compositions are disclosed comprising about 0.1 weight percent to about 99.9 weight percent Z-1,2,3,3,3-pentafluoropropene (Z-1225ye) and about 99.9 weight percent to about 0.1 weight percent E-1,2,3,3,3-pentafluoropropene (E-1225ye).

Also disclosed is a method for increasing refrigeration capacity for 1,2,3,3,3-pentafluoropropene (HFC-1225ye), said method comprising increasing the amount of Z-isomer (Z-1225ye) relative to the amount of E-isomer (E-1225ye).

### BACKGROUND OF THE INVENTION

1. Field of the Invention

The present disclosure relates to compositions comprising 1,2,3,3,3-pentafluoropropene wherein the isomer ratio of Z- and E-isomers has been optimized for refrigeration performance. In particular the present disclosure relates to azeotropic or near-azeotropic compositions comprising Z- and E-1,2,3,3,3-pentafluoropropene.

2. Description of Related Art

The refrigeration and air-conditioning industry in response to regulatory phase out of existing refrigerants with high global warming potential (GWP) is interested in identifying new refrigerant and heat transfer compositions. The new refrigerants or heat transfer compositions must have low GWP, low ozone depletion potential (ODP), be non-toxic, non-flammable and provide refrigeration capacity and energy efficiency comparable to the currently used materials.

There is a need to provide new compounds that meet all the above criteria to replace higher GWP refrigerant and heat transfer compositions.

Fluoroolefins have been indentified as potential new refrigerant and heat transfer composition compounds. In particular, certain trifluoropropenes, tetrafluoropropenes, and pentafluoropropenes possess all the required characteristics. 1,2,3,3,3-pentafluoropropene (HFC-1225ye) has specifically been disclosed as having good potential as a new refrigerant or heat transfer composition. HFC-1225ye comprises two different stereoisomers, being the Z- and E-isomers. Any process used to make HFC-1225ye will produce a mixture of these isomers.

The present disclosure relates to particular compositions comprising E- and Z-HFC-1225ye that provide superior performance in refrigeration and air-conditioning apparatus.

### BRIEF SUMMARY OF THE INVENTION

The present disclosure provides an azeotropic or near-azeotropic composition comprising about 0.1 weight percent to about 99.9 weight percent Z-1,2,3,3,3-pentafluoropropene (Z-1225ye) and about 99.9 weight percent to about 0.1 weight percent E-1,2,3,3,3-pentafluoropropene (E-1225ye).

The present disclosure also provides a method for increasing refrigeration capacity for 1,2,3,3,3-pentafluoropropene (HFC-1225ye), said method comprising increasing the amount of Z-isomer (Z-1225ye) relative to the amount of E-isomer (E-1225ye).

### DETAILED DESCRIPTION OF THE INVENTION

1,2,3,3,3-pentafluoropropene (HFC-1225ye, CF₃CF═CHF) may be one of two stereoisomers, E- or Z-. Both Z-HFC-1225ye (referred to herein as Z-1225ye; CAS reg. no. [5528-43-8]) and E-HFC-1225ye (referred to herein as E-1225ye; CAS reg. no. [5525-10-8]) may be prepared by vapor phase dehydrofluorination of 1,1,1,2,3,3-hexafluoropropane (HFC-236ea, CF₃CHFCHF₂). Generally, the present dehydrofluorination may be carried out in a similar manner to processes known in the art. Of particular utility are processes using any dehydrofluorination catalyst, such as described in U.S. Patent Application Publication No. 2006/0106263 A1.

In the preparation of HFC-1225ye from HFC-236ea, both E- and Z-isomers are produced. The amount of each isomer in the product mixture may vary depending upon the catalyst and reaction variables such as temperature, pressure and catalyst contact time. Distillation may be used to separate the isomers or to enrich a mixture of both isomers in the Z-1225ye isomer. Such distillations may include for example azeotropic distillation as described in PCT Patent Application No. PCT/US07/19657, filed Sep. 7, 2007.

In one embodiment the present disclosure provides an azetropic or near-azeotropic composition comprising about 0.1 weight percent to about 99.9 weight percent Z-1225ye and about 99.9 weight percent to about 0.1 weight percent E-1225ye.

In another embodiment the present disclosure provides a composition comprising about 60 weight percent to about 99.9 weight percent Z-1225ye and about 40 weight percent to about 0.1 weight percent E-1225ye.

In another embodiment the present disclosure provides a composition comprising about 85 weight percent to about 99.9 weight percent Z-1225ye and about 15 weight percent to about 0.1 weight percent E-1225ye.

In yet another embodiment the present disclosure provides a composition comprising about 95 weight percent to about 99.9 weight percent Z-1225ye and about 5 weight percent to about 0.1 weight percent E-1225ye.

These compositions have a variety of utilities in working fluids, which include use as These compositions have a variety of utilities in working fluids, which include foam expansion agents, solvents, aerosol propellants, fire extinguishing agents, sterilants, gaseous dielectrics, power cycle working fluids, or heat transfer mediums (such as heat transfer fluids and refrigerants for use in refrigeration systems, refrigerators, air conditioning systems, heat pumps, chillers, and the like), to name a few.

A foam expansion agent is a volatile composition that expands a polymer matrix to form a cellular structure (e.g., for polyolefins and polyurethane foams).

A solvent is a fluid that removes a soil from a substrate, or deposits a material onto a substrate, or carries a material.

An aerosol propellant is a volatile composition of one or more components that exerts a pressure greater than one atmosphere to expel a material from a container.

A fire extinguishing agent is a volatile composition that extinguishes or suppresses a flame.

A sterilant is a volatile biocidal fluid or blend containing a volatile biocidal fluid that destroys a biologically active material or the like.

A heat transfer medium (also referred to herein as a heat transfer fluid, a heat transfer composition or a heat transfer fluid composition) is a working fluid used to carry heat from a heat source to a heat sink.

As used herein, heat transfer compositions are compositions utilized to transfer, move or remove heat from one space, location, object or body to a different space, location, object or body by radiation, conduction, or convection. A heat transfer composition, may be a liquid or a gas fluid and may function as a secondary coolant by providing means of transfer for cooling (or heating) from a remote refrigeration (or heating) system. In some systems, the heat transfer compositions may remain in a constant state throughout the transfer process (i.e., not evaporate or condense). Alternatively, evaporative cooling processes may utilize heat transfer fluids as well.

As used herein, a heat source may be defined as any space, location, object or body from which it is desirable to transfer, move or remove heat. Examples of heat sources may be spaces (open or enclosed) requiring refrigeration or cooling, such as refrigerator or freezer cases in a supermarket, building spaces requiring air-conditioning, or the passenger compartment of an automobile requiring air-conditioning. A heat sink may be defined as any space, location, object or body capable of absorbing heat. A vapor compression refrigeration system is one example of such a heat sink.

A refrigerant is a compound or mixture of compounds that functions as a heat transfer composition in a cycle wherein the composition undergoes a phase change from a liquid to a gas and back to a liquid.

While the process to produce HFC-1225ye actually makes a mixture of isomers, it has been surprisingly found that mixtures of Z-1225ye and E-1225ye with higher levels of Z-1225ye provide better refrigeration capacity and thus are more desirable as refrigerant or heat transfer compositions.

Refrigeration capacity is a term to define the change in enthalpy of a refrigerant in an evaporator per pound of refrigerant circulated, i.e., the heat removed by the refrigerant in the evaporator per a given time. The refrigeration capacity is a measure of the ability of a refrigerant or heat transfer composition to produce cooling. Therefore, the higher the capacity the greater the cooling that may be produced.

The compositions as disclosed herein have been found to be azeotropic or near-azeotropic compositions. By azeotropic composition is meant a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a refrigeration or air conditioning system during operation, which may reduce efficiency of the system. Additionally, an azeotropic composition will not fractionate upon leakage from a refrigeration or air conditioning system. In the situation where one component of a mixture is flammable, fractionation during leakage could lead to a flammable composition either within the system or outside of the system.

A near-azeotropic composition (also commonly referred to as an “azeotrope-like composition”) is a substantially constant boiling liquid admixture of two or more substances that behaves essentially as a single substance. One way to characterize a near-azeotropic composition is that the vapor produced by partial evaporation or distillation of the liquid has substantially the same composition as the liquid from which it was evaporated or distilled, that is, the admixture distills/refluxes without substantial composition change. Another way to characterize a near-azeotropic composition is that the bubble point vapor pressure and the dew point vapor pressure of the composition at a particular temperature are substantially the same. Herein, a composition is near-azeotropic if, after 50 weight percent of the composition is removed, such as by evaporation or boiling off, the difference in vapor pressure between the original composition and the composition remaining after 50 weight percent of the original composition has been removed is less than about 10 percent.

Azeotropic or near-azeotropic compositions do not tend to fractionate to a large degree during leakage from equipment. In some equipment, refrigerant or heat transfer composition may be lost during equipment operation through leaks in shaft seals, hose connections, soldered joints and broken lines or during equipment repair and maintenance resulting in the heat transfer composition being released into the atmosphere. If the refrigerant or heat transfer composition in the equipment is not a pure component, an azeotropic composition, or an azeotrope-like composition, the heat transfer composition may change when leaked or discharged to the atmosphere from the equipment. Changes in the composition may cause the heat transfer performance of the composition to deteriorate.

The compositions disclosed herein may additionally contain other compounds selected from the group consisting of fluoroolefins, hydrofluorocarbons, hydrocarbons, dimethyl ether, CF₃I, carbon dioxide (CO₂), and ammonia.

Fluoroolefins that may be included in the compositions disclosed herein comprise unsaturated compounds containing carbon, fluorine and optionally hydrogen. Such fluoroolefins may include 2,3,3,3-tetrafluoropropene (CF₃CF═CH₂ or HFC-1234yf); 1,3,3,3-tetrafluoropropene (CF₃CH═CHF or HFC-1234ze); 3,3,3-trifluoropropene (CF₃CH═CH₂ or HFC-1243zf); and 1,1,1,4,4,4-hexafluoro-2-butene (CF₃CH═CHCF₃ or HFC-1336m/z), and others as described in U.S. patent application Ser. No. 11/589,588, filed Oct. 30, 2006.

Fluoroolefin compounds as may be included in the compositions disclosed herein may exist as different configurational isomers or stereoisomers. The present invention is intended to include all single configurational isomers, single stereoisomers or any combination or mixture thereof. For instance, 1,3,3,3-tetra-fluoropropene (or HFC-1234ze) is meant to represent the Z-isomer, E-isomer, or any combination or mixture of both isomers in any ratio.

Hydrofluorocarbons that may be included in the compositions disclosed herein comprise saturated compounds containing carbon, hydrogen, and fluorine. Of particular utility are hydrofluorocarbons having 1-7 carbon atoms and having a normal boiling point of from −90° C. to 80° C. Hydrofluorocarbons are commercial products available from a number of sources such as E.I. du Pont de Nemours and Company, Fluoroproducts, Wilmington, Del., 19898, USA, or may be prepared by methods known in the art. Representative hydrofluorocarbon compounds include but are not limited to fluoromethane (CH₃F, HFC-41), difluoromethane (CH₂F₂, HFC-32), trifluoromethane (CHF₃, HFC-23), pentafluoroethane (CF₃CHF₂, HFC-125), 1,1,2,2-tetrafluoroethane (CHF₂CHF₂, HFC-134), 1,1,1,2-tetrafluoroethane (CF₃CH₂F, HFC-134a), 1,1,1-trifluoroethane (CF₃CH₃, HFC-143a), 1,1-difluoroethane (CHF₂CH₃, HFC-152a), fluoroethane (CH₃CH₂F, HFC-161), 1,1,1,2,2,3,3-heptafluoropropane (CF₃CF₂CHF₂, HFC-227ca), 1,1,1,2,3,3,3-heptafluoropropane (CF₃CHFCF₃, HFC-227ea), 1,1,2,2,3,3,-hexafluoropropane (CHF₂CF₂CHF₂, HFC-236ca), 1,1,1,2,2,3-hexafluoropropane (CF₃CF₃CH₂F, HFC-236cb), 1,1,1,2,3,3-hexafluoropropane (CF₃CHFCHF₂, HFC-236ea), 1,1,1,3,3,3-hexafluoropropane (CF₃CH₂CF₃, HFC-236fa), 1,1,2,2,3-pentafluoropropane (CHF₂CF₂CH₂F, HFC-245ca), 1,1,1,2,2-pentafluoropropane (CF₃CF₂CH₃, HFC-245cb), 1,1,2,3,3-pentafluoropropane (CHF₂CHFCHF₂, HFC-245ea), 1,1,1,2,3-pentafluoropropane (CF₃CHFCH₂F, HFC-245eb), 1,1,1,3,3-pentafluoropropane (CF₃CH₂CHF₂, HFC-245fa), 1,2,2,3-tetrafluoropropane (CH₂FCF₂CH₂F, HFC-254ca), 1,1,2,2-tetrafluoropropane (CHF₂CF₂CH₃, HFC-254cb), 1,1,2,3-tetrafluoropropane (CHF₂CHFCH₂F, HFC-254ea), 1,1,1,2-tetrafluoropropane (CF₃CHFCH₃, HFC-254eb), 1,1,3,3-tetrafluoropropane (CHF₂CH₂CHF₂, HFC-254fa), 1,1,1,3-tetrafluoropropane (CF₃CH₂CH₂F, HFC-254fb), 1,1,1-trifluoropropane (CF₃CH₂CH₃, HFC-263fb), 2,2-difluoropropane (CH₃CF₂CH₃, HFC-272ca), 1,2-difluoropropane (CH₂FCHFCH₃, HFC-272ea), 1,3-difluoropropane (CH₂FCH₂CH₂F, HFC-272fa), 1,1-difluoropropane (CHF₂CH₂CH₃, HFC-272fb), 2-fluoropropane (CH₃CHFCH₃, HFC-281ea), 1-fluoropropane (CH₂FCH₂CH₃, HFC-281fa), 1,1,2,2,3,3,4,4-octafluorobutane (CHF₂CF₂CF₂CHF₂, HFC-338 pcc), 1,1,1,2,2,4,4,4-octafluorobutane (CF₃CH₂CF₂CF₃, HFC-338mf), 1,1,1,3,3-pentafluorobutane (CF₃CH₂CHF₂, HFC-365mfc), 1,1,1,2,3,4,4,5,5,5-decafluoropentane (CF₃CHFCHFCF₂CF₃, HFC-43-10mee), and 1,1,1,2,2,3,4,5,5,6,6,7,7,7-tetradecafluoroheptane (CF₃CF₂CHFCHFCF₂CF₂CF₃, HFC-63-14mee).

Of particular note are compositions as disclosed herein containing at least one hydrofluorocarbon selected from the group consisting of HFC-32, HFC-125, HFC-134a, HFC-143a, HFC-152a, HFC-227ea, HFC-236fa, HFC-245fa, and HFC-365mfc.

Hydrocarbons that may be included in the compositions disclosed herein comprise compounds having only carbon and hydrogen. Of particular utility are compounds having 3-7 carbon atoms. Hydrocarbons are commercially available through numerous chemical suppliers. Representative hydrocarbons include but are not limited to propane, n-butane, isobutane, cyclobutane, n-pentane, 2-methylbutane, 2,2-dimethylpropane, cyclopentane, n-hexane, 2-methylpentane, 2,2-dimethylbutane, 2,3-dimethylbutane, 3-methylpentane, cyclohexane, n-heptane, and cycloheptane.

Other compounds that may be included in the compositions disclosed herein comprise at least one selected from the group consisting of DME (dimethyl ether), iodotrifluoromethane (CF₃I), carbon dioxide (CO₂), and ammonia (NH₃). All of these compounds are commercially available or may be prepared by known methods.

Various other components or additives may be present in the compositions as disclosed herein. These other components include lubricants typically used in refrigeration and air conditioning systems, including polyalkylene glycols (PAGs), polyol esters (POEs), polyvinylethers (PVEs), mineral oils, alkylbenzenes, synthetic paraffins, synthetic napthenes, and poly(alpha)olefins. Additionally, stabilizers such as water scavengers, acid scavengers, antioxidants and others may be present in the compositions disclosed herein.

In one embodiment, the present disclosure provides a method for increasing refrigeration capacity for HFC-1225ye said method comprising increasing the amount of Z-isomer relative to the amount of E-isomer. The amount of E-1225ye present in a mixture of Z-1225ye and E-1225ye will be dependent upon the process variables utilized in the production process. The amount of E-1225ye may be reduced by distillation such as azeotropic distillation as described in U.S. Provisional Patent Application No. 60/843,020. Thus it is possible to control the amount of E-1225ye present in a mixture of Z-1225ye and E-1225ye and thereby fine tune the refrigeration capacity produced by the mixture.

Vapor-compression refrigeration, air-conditioning, or heat pump systems include an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator at a low temperature to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

The present invention further relates to a process for producing cooling comprising evaporating the compositions of the present invention in the vicinity of a body to be cooled, and thereafter condensing said compositions.

The present invention further relates to a process for producing heat comprising condensing the compositions of the present invention in the vicinity of a body to be heated, and thereafter evaporating said compositions.

In another embodiment, the present invention relates to foam expansion agent compositions comprising the fluoroolefin-containing compositions of the present invention as described herein for use in preparing foams. In other embodiments the invention provides foamable compositions, and preferably polyurethane and polyisocyanate foam compositions, and method of preparing foams. In such foam embodiments, one or more of the present fluoroolefin-containing compositions are included as a foam expansion agent in foamable compositions, which composition preferably includes one or more additional components capable of reacting and foaming under the proper conditions to form a foam or cellular structure. Any of the methods well known in the art, such as those described in “Polyurethanes Chemistry and Technology,” Volumes I and II, Saunders and Frisch, 1962, John Wiley and Sons, New York, N.Y., may be used or adapted for use in accordance with the foam embodiments of the present invention.

The present invention further relates to a method of forming a foam comprising: (a) adding to a foamable composition a fluoroolefin-containing composition of the present invention; and (b) reacting the foamable composition under conditions effective to form a foam.

Another embodiment of the present invention relates to the use of the fluoroolefin-containing compositions as described herein for use as propellants in sprayable compositions. Additionally, the present invention relates to a sprayable composition comprising the fluoroolefin-containing compositions as described herein. The active ingredient to be sprayed together with inert ingredients, solvents and other materials may also be present in a sprayable composition. Preferably, the sprayable composition is an aerosol. Suitable active materials to be sprayed include, without limitations, cosmetic materials, such as deodorants, perfumes, hair sprays, cleaners, and polishing agents as well as medicinal materials such as anti-asthma and anti-halitosis medications.

The present invention further relates to a process for producing aerosol products comprising the step of adding a fluoroolefin-containing composition as described herein to active ingredients in an aerosol container, wherein said composition functions as a propellant.

A further aspect provides methods of suppressing a flame, said methods comprising contacting a flame with a fluid comprising a fluoroolefin-containing composition of the present disclosure. Any suitable methods for contacting the flame with the present composition may be used. For example, a fluoroolefin-containing composition of the present disclosure may be sprayed, poured, and the like onto the flame, or at least a portion of the flame may be immersed in the flame suppression composition. In light of the teachings herein, those of skill in the art will be readily able to adapt a variety of conventional apparatus and methods of flame suppression for use in the present disclosure.

A further embodiment provides methods of extinguishing or suppressing a fire in a total-flood application comprising providing an agent comprising a fluoroolefin-containing composition of the present disclosure; disposing the agent in a pressurized discharge system; and discharging the agent into an area to extinguish or suppress fires in that area.

Another embodiment provides methods of inerting an area to prevent a fire or explosion comprising providing an agent comprising a fluoroolefin-containing composition of the present disclosure; disposing the agent in a pressurized discharge system; and discharging the agent into the area to prevent a fire or explosion from occurring.

The term “extinguishment” is usually used to denote complete elimination of a fire; whereas, “suppression” is often used to denote reduction, but not necessarily total elimination, of a fire or explosion. As used herein, terms “extinguishment” and “suppression” will be used interchangeably. There are four general types of halocarbon fire and explosion protection applications. (1) In total-flood fire extinguishment and/or suppression applications, the agent is discharged into a space to achieve a concentration sufficient to extinguish or suppress an existing fire. Total flooding use includes protection of enclosed, potentially occupied spaces such, as computer rooms as well as specialized, often unoccupied spaces such as aircraft engine nacelles and engine compartments in vehicles. (2) In streaming applications, the agent is applied directly onto a fire or into the region of a fire. This is usually accomplished using manually operated wheeled or portable units. A second method, included as a streaming application, uses a “localized” system, which discharges agent toward a fire from one or more fixed nozzles. Localized systems may be activated either manually or automatically. (3) In explosion suppression, a fluoroolefin-containing composition of the present disclosure is discharged to suppress an explosion that has already been initiated. The term “suppression” is normally used in this application because the explosion is usually self-limiting. However, the use of this term does not necessarily imply that the explosion is not extinguished by the agent. In this application, a detector is usually used to detect an expanding fireball from an explosion, and the agent is discharged rapidly to suppress the explosion. Explosion suppression is used primarily, but not solely, in defense applications. (4) In inertion, a fluoroolefin-containing composition of the present disclosure is discharged into a space to prevent an explosion or a fire from being initiated. Often, a system similar or identical to that used for total-flood fire extinguishment or suppression is used. Usually, the presence of a dangerous condition (for example, dangerous concentrations of flammable or explosive gases) is detected, and the fluoroolefin-containing composition of the present disclosure is then discharged to prevent the explosion or fire from occurring until the condition can be remedied.

The extinguishing method can be carried out by introducing the composition into an enclosed area surrounding a fire. Any of the known methods of introduction can be utilized provided that appropriate quantities of the composition are metered into the enclosed area at appropriate intervals. For example, a composition can be introduced by streaming, e.g., using conventional portable (or fixed) fire extinguishing equipment; by misting; or by flooding, e.g., by releasing (using appropriate piping, valves, and controls) the composition into an enclosed area surrounding a fire. The composition can optionally be combined with an inert propellant, e.g., nitrogen, argon, decomposition products of glycidyl azide polymers or carbon dioxide, to increase the rate of discharge of the composition from the streaming or flooding equipment utilized.

Preferably, the extinguishing process involves introducing a fluoroolefin-containing composition of the present disclosure to a fire or flame in an amount sufficient to extinguish the fire or flame. One skilled in this field will recognize that the amount of flame suppressant needed to extinguish a particular fire will depend upon the nature and extent of the hazard. When the flame suppressant is to be introduced by flooding, cup burner test data is useful in determining the amount or concentration of flame suppressant required to extinguish a particular type and size of fire.

Laboratory tests useful for determining effective concentration ranges of fluoroolefin-containing compositions when used in conjunction with extinguishing or suppressing a fire in a total-flood application or fire inertion are described, for example, in U.S. Pat. No. 5,759,430.

### EXAMPLES

### Example 1

### Dehydrofluorination of HFC-236ea to HFC-1225ye (E- and Z- isomers) over carbonaceous Catalyst

A Hastelloy™ nickel alloy reactor (2.54 cm OD×2.17 cm ID×24.1 cm L) was charged with 14.32 g (25 mL) of spherical (8 mesh) three dimensional matrix porous carbonaceous material prepared substantially as described in U.S. Pat. No. 4,978,649. The packed portion of the reactor was heated by a 5″×1″ ceramic band heater clamped to the outside of the reactor. A thermocouple positioned between the reactor wall and the heater measured the reactor temperature. After charging the reactor with the carbonaceous material, nitrogen (10 ml/min, 1.7×10⁻⁷ m³/s) was passed through the reactor and the temperature was raised to 200° C. during a period of one hour and maintained at this temperature for an additional 4 hours. The reactor temperature was then raised to the desired operating temperature and a flow of HFC-236ea and nitrogen was started through the reactor.

A portion of the total reactor effluent was sampled on-line for organic product analysis using a gas chromatograph equipped with a mass selective detector (GC-MS); the results are summarized in Table 1.

The bulk of the reactor effluent containing organic products and also inorganic acid, such as HF, was treated with aqueous caustic for neutralization.

TABLE 1

| | HFC- | | | | | |
|---|---|---|---|---|---|---|
| Reactor | 236ea | | GC Area Percent | | | |
| Temp. | feed | N₂ feed | Z- | E- | Unreacted | |
| (° C.) | (mL/min) | (mL/min) | 1225ye | 1225ye | HFC-236ea | Unks |
| 200 | 10 | 20 | 0.03 | ND | 99.97 | ND |
| 250 | 10 | 20 | 0.2 | 0.03 | 99.8 | ND |
| 300 | 10 | 20 | 1.4 | 0.22 | 98.4 | 0.01 |
| 350 | 10 | 20 | 5.4 | 0.96 | 93.1 | 0.5 |
| 400 | 10 | 20 | 38.1 | 9.0 | 51.7 | 1.1 |
| 400 | 10 | 10 | 37.9 | 8.7 | 51.6 | 1.8 |
| 400 | 10 | 5 | 42.6 | 9.5 | 46.7 | 1.2 |
| 400 | 10 | 40 | 13.2 | 2.5 | 71.6 | 12.7 |

ND = not detected
Unks = unknowns

### Example 2

### Refrigeration Performance Data

Table 2 shows refrigeration performance for various mixtures of E-1225ye and Z-1225ye as compared to pure Z-1225ye. In Table 2, Evap Pres is evaporator pressure, Cond Pres is condenser pressure, and Comp Disch T is compressor discharge temperature. The data are based on the following conditions.

| Evaporator temperature | 40.0° F. (4.4° C.) |
|---|---|
| Condenser temperature | 110.0° F. (43.3° C.) |
| Subcool amount | 10.0° F. (5.5° C.) |
| Return gas temperature | 60.0° F. (15.6° C.) |
| Compressor efficiency is | 100% |

Note that the superheat is included in cooling capacity.

TABLE 2

| | | | | | | | | | Capacity |
|---|---|---|---|---|---|---|---|---|---|
| Composition | Evap | Evap | Cond | Cond | Comp | Comp | | | Relative |
| Z-1225ye/E-1225ye | Pres | Pres | Pres | Pres | Disch T | Disch T | Capacity | Capacity | to pure |
| (weight percent) | (Psia) | (kPa) | (Psia) | (kPa) | (F.) | (C.) | (Btu/min) | (kW) | Z-1225ye |
| 100/0 | 37.6 | 259 | 124.0 | 855 | 127.2 | 52.9 | 181.6 | 3.51 | 100% |
| 99.9/0.1 | 37.6 | 259 | 124.0 | 855 | 127.2 | 52.9 | 181.6 | 3.51 | 100% |
| 99/1 | 37.5 | 259 | 123.8 | 854 | 127.2 | 52.9 | 181.2 | 3.50 | 100% |
| 95/5 | 37.2 | 256 | 122.7 | 846 | 127.2 | 52.9 | 179.4 | 3.47 | 99% |
| 90/10 | 36.8 | 254 | 121.2 | 836 | 127.1 | 52.8 | 177.4 | 3.43 | 98% |
| 85/15 | 36.5 | 252 | 119.8 | 826 | 126.9 | 52.7 | 175.7 | 3.40 | 97% |
| 80/20 | 36.1 | 249 | 118.5 | 817 | 126.7 | 52.6 | 173.6 | 3.36 | 96% |
| 70/30 | 35.4 | 244 | 115.7 | 798 | 126.6 | 52.6 | 169.9 | 3.29 | 94% |
| 60/40 | 34.6 | 239 | 112.9 | 778 | 126.3 | 52.4 | 166.0 | 3.21 | 91% |
| 50/50 | 33.8 | 233 | 110.2 | 760 | 126.2 | 52.3 | 162.1 | 3.14 | 89% |
| 40/60 | 33.1 | 228 | 107.6 | 742 | 125.9 | 52.2 | 158.3 | 3.06 | 87% |

The data above indicates that compositions with less than about 40 weight percent E-1225ye have less than about 10% loss in capacity. Additionally, compositions with less than about 15 weight percent E-1225ye show less than about 3% loss in capacity. Finally, compositions with less than about 5 weight percent E-1225ye have less than about 1% loss in capacity.

### Example 3

### Impact of Vapor Leakage

A vessel is charged with an initial composition at a temperature of 25° C., and the initial vapor pressure of the composition is measured. The composition is allowed to leak from the vessel, while the temperature is held constant, until 50 weight percent of the initial composition is removed, at which time the vapor pressure of the composition remaining in the vessel is measured. Calculated results are shown in Table 3.

TABLE 3

| Composition | | | | | |
|---|---|---|---|---|---|
| Z-1225ye/ | | | | | |
| E-1225ye | Initial | Initial | Pressure | Pressure | Change in |
| (weight | Pressure | Pressure | After 50% | After 50% | pressure |
| percent) | (Psia) | (kPa) | Leak (Psia) | Leak (kPa) | (%) |
| 0.1/99.9 | 62.7 | 432 | 62.7 | 432 | 0.0% |
| 1/99 | 62.8 | 433 | 62.8 | 433 | 0.0% |
| 10/90 | 63.8 | 440 | 63.7 | 439 | 0.2% |
| 20/80 | 65.0 | 448 | 64.7 | 446 | 0.5% |
| 30/70 | 66.1 | 456 | 65.8 | 454 | 0.5% |
| 40/60 | 67.3 | 464 | 66.9 | 461 | 0.6% |
| 50/50 | 68.5 | 472 | 68.1 | 470 | 0.6% |
| 60/40 | 69.7 | 481 | 69.3 | 478 | 0.6% |
| 70/30 | 70.8 | 488 | 70.6 | 487 | 0.3% |
| 80/20 | 71.9 | 496 | 71.7 | 494 | 0.3% |
| 90/10 | 72.9 | 503 | 72.8 | 502 | 0.1% |
| 99/1 | 73.7 | 508 | 73.7 | 508 | 0.0% |
| 99.9/0.1 | 73.7 | 508 | 73.7 | 508 | 0.0% |

The difference in vapor pressure between the original composition and the composition remaining after 50 weight percent is removed is less then about 10 percent for compositions of the present invention. This indicates that compositions comprising about 0.1 weight percent to about 99.9 weight percent Z-1225ye and about 99.9 weight percent and about 0.1 weight percent E-1225ye are azeotropic or near-azeotropic compositions.

What is claimed is:

1. An azeotropic or near-azeotropic composition comprising about 0.1 weight percent to about 99.9 weight percent Z-1,2,3,3,3-pentafluoropropene and about 99.9 weight percent to about 0.1 weight percent E-1,2,3,3,3-pentafluoropropene.

2. The composition of claim 1 comprising about 60 weight percent to about 99.9 weight percent Z-1,2,3,3,3-pentafluoropropene and about 40 weight percent to about 0.1 weight percent E-1,2,3,3,3-pentafluoropropene.

3. The composition of claim 1 comprising about 85 weight percent to about 99.9 weight percent Z-1,2,3,3,3-pentafluoropropene and about 15 weight percent to about 0.1 weight percent E-1,2,3,3,3-pentafluoropropene.

4. The composition of claim 1 comprising about 95 weight percent to about 99.9 weight percent Z-1,2,3,3,3-pentafluoropropene and about 5 weight percent to about 0.1 weight percent E-1,2,3,3,3-pentafluoropropene.

5. The composition of claim 1 further comprising an additional compound selected from the group consisting of fluoroolefins, hydrofluorocarbons, hydrocarbons, dimethyl ether, CF₃I, carbon dioxide (CO₂), and ammonia.

6. The composition of claim 5 wherein said hydrofluorocarbon comprises at least one compound selected from the group consisting of difluoromethane, pentafluoroethane, 1,1,1,2-tetrafluoroethane, 1,1,1-trifluoroethane, 1,1,-difluoroethane, 1,1,1,2,3,3,3-heptafluoropropane, 1,1,1,3,3,3-hexafluoropropane, 1,1,1,3,3-pentafluoropropane, and 1,1,1,3,3-pentafluorobutane.

7. The composition of claim 5 wherein said fluoroolefin comprises at least one compound selected from the group consisting of 2,3,3,3-tetrafluoropropene; 1,3,3,3-tetrafluoropropene; 3,3,3-trifluoropropene; and 1,1,1,4,4,4-hexafluoro-2-butene.

8. The composition of claim 1, further comprising a lubricant selected from the group consisting of polyalkylene glycols (PAGs), polyol esters (POEs), polyvinylethers (PVEs), mineral oils, alkylbenzenes, synthetic paraffins, synthetic napthenes, and poly(alpha)olefins

9. A method for increasing refrigeration capacity for 1,2,3,3,3-pentafluoropropene said method comprising increasing the amount of Z-isomer relative to the amount of E-isomer.

10. A process for producing cooling comprising evaporating a composition of claim 1, in the vicinity of a body to be cooled and thereafter condensing said composition.

11. A process for producing heating comprising condensing a composition of claim 1, in the vicinity of a body to be heated and thereafter evaporating said composition.

12. A foam blowing agent comprising the composition of claim 1.

13. A method of forming a foam comprising:
(a) adding to a foamable composition the composition of claim 1; and
(b) reacting the foamable composition under conditions effective to form a foam.

14. A sprayable composition comprising the composition of claim 1.

15. A process for producing aerosol products comprising the step of adding the composition of claim 1 to active ingredients in an aerosol container, wherein said composition functions as a propellant.

16. A method of suppressing a flame comprising contacting the flame with a fluid comprising the composition of claim 1.

17. A method of extinguishing or suppressing a fire in a total-flood application comprising:
(a) providing an agent comprising the composition of claim 1;
(b) disposing the agent in a pressurized discharge system; and
(c) discharging the agent into an area to extinguish or suppress fires in that area.

18. A method of inerting an area to prevent a fire or explosion comprising:
(a) providing an agent comprising the composition of claim 1;
(b) disposing the agent in a pressurized discharge system; and
(c) discharging the agent into the area to prevent a fire or explosion from occurring.
